(19) United States
(12) Patent Application Publication
(10) Pub. No.: US 2010/0166532 A1
(43) Pub. Date: Jul. 1, 2010

(54) Apparatus for manipulating and recovering wheels

(76) Inventor: Winfield J. Garnett, Harvey, IL (US)

Correspondence Address: MARTIN E. JERISAT, Suite 3300, 10 S. LaSalle Street, Chicago, IL, 60603, US

(21) Appl. No.: 12/317,770

(22) Filed: Dec. 30, 2008

(51) Int. Cl. B60P 1/04; B66F 9/06

(52) U.S. Cl. 414/471; 187/237

(57) ABSTRACT

An apparatus is disclosed here for manipulating and recovery of wheels. The apparatus may include a housing and a lift operatively attached to the housing for manipulating and recovering the wheels. The apparatus may be adapted to inflate tires, and lift vehicles to facilitate changing of tires.

### BACKGROUND

1. Field

This invention is generally related to the field of motor vehicle servicing. More specifically, the present invention relates to an apparatus for manipulating, lifting and carrying vehicle wheels for small and big vehicles.

2. Background of the Invention

One of the problems that this invention solve is changing tires on large and heavy vehicles in urban or rough terrains. The prior art methods employ manpower to unload and lift defective tires and replace them with good tires. At least two individuals are needed to change a single defective tire. Because of the heavy weight and big size of tires of heavy vehicles injuries are common in this field. Injuries may occur during lifting of the vehicles and/ or carrying the tires. Adverse and rough terrains complicate the process and make it more challenging. Additionally, big vehicles lack any resources to inflate flat tires.

Accordingly, there is a need for a apparatus that minimizes the use of manpower, minimizes the risk of injuries, and capable of changing tires in a quick and efficient manner and lifting vehicles and inflate tires, if needed.

### SUMMARY OF THE INVENTION

The objects mentioned above, as well as other objects, are solved by the present invention, which overcomes disadvantages while providing new advantages not previously obtainable in the prior art.

The problem of changing tires on large and heavy vehicles in urban or adverse settings is solved by a mechanical apparatus that enables lifting of the vehicle, unloading defective tires and loading good tires.

In an embodiment, the invention comprises a apparatus adapted for manipulating and recovering wheels from vehicles. The apparatus may include a housing that may have a power source to power the apparatus. The power source may be a motor that may be attached to a motor assembly frame operationally connected to the housing. The motor assembly frame may be operatively connected to a steering linkage that may be attached to steering column. A control console may be used for controlling the apparatus.

The apparatus may include at least one compressor for inflation of tires, and at least one lifting mechanism for lifting a vehicle to a facilitate changing of tires.

The apparatus may have a front section. The apparatus may have at least one lift to manipulate and recover the wheels. The lift may be attached to the apparatus. The lift may be pivotally attached to the front section of the housing. Additionally, the apparatus may have the ability to inflate flat tires.

The lift may include a tire rest plate for supporting a tire and may be connected to a tire roller bearings for retaining the tire. The lift may include a handler mechanism that moves between an open position for receiving the wheel and a closed position for retaining and securing the wheel. The handler mechanism may include at least one retainer arm, or a pair of extending arms or a plurality of arms.

In an alternative embodiment, the invention includes an apparatus adapted for manipulating and recovery of wheels. The apparatus may comprise a housing and a power source to power the apparatus. The apparatus may include a lift that may be attached to the housing for manipulating and recovering the wheels. The apparatus may also be adapted to inflate tires. The apparatus may also be adapted to lift vehicles to facilitate changing of tires. The apparatus may also be adapted to carry and lift good tires. The apparatus may also be operated manually.

In another embodiment, the invention may include a apparatus adapted for manipulating and recovering wheels. The apparatus may include a housing, a means for powering the apparatus, a mean for lifting and manipulating wheels, and a mean for inflating tires. The apparatus may also include a means for lifting vehicles. The apparatus may include a means for carrying and lifting wheels. The apparatus may also include a remote controlling means.

### BRIEF DESCRIPTION OF THE DRAWINGS

The novel features which are characteristic of the invention are set forth in the appended claims. The invention itself however, together with further objects and attendant advantages thereof, will be best understood by reference to the following description taken in connection with the accompanying drawings, in which:

FIG. 1 is a side view of an embodiment according to the present invention;

FIG. 2 is an exploded view of the embodiment shown in FIG. 1;

FIG. 3 is a plan view of the embodiment shown in FIG. 1;

FIG. 4 is another embodiment according to the present invention; and

FIG. 5 is an exploded view of alternative embodiment.

### DETAILED DESCRIPTION

Set forth below is a description of what are believed to be the preferred embodiment and/or best examples of the invention claimed. Future and present alternatives and modifications to this preferred embodiment are contemplated. Any alternatives or modifications that make insubstantial changes in function, in purpose, in structure, or in result are intended to be covered by the claims of this patent.

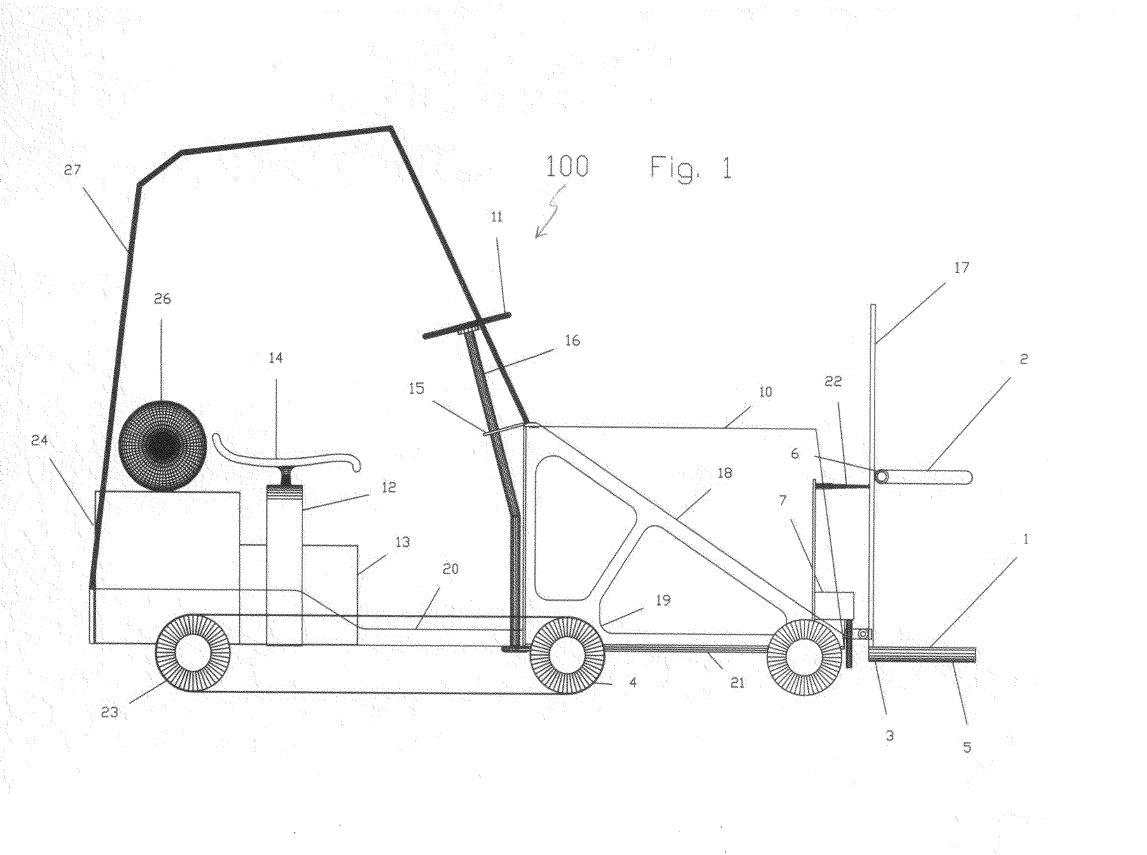

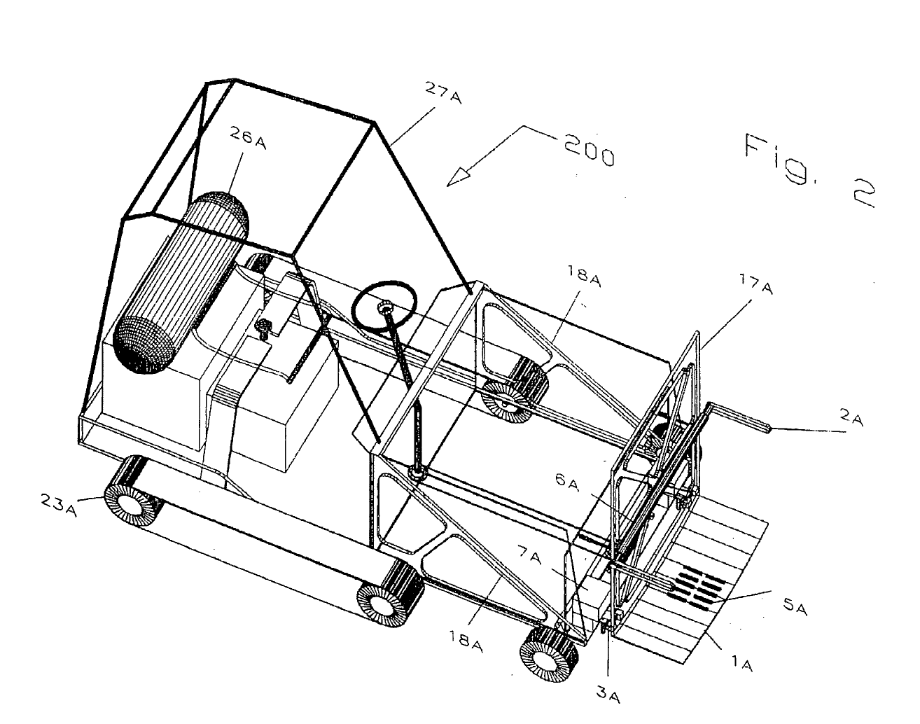

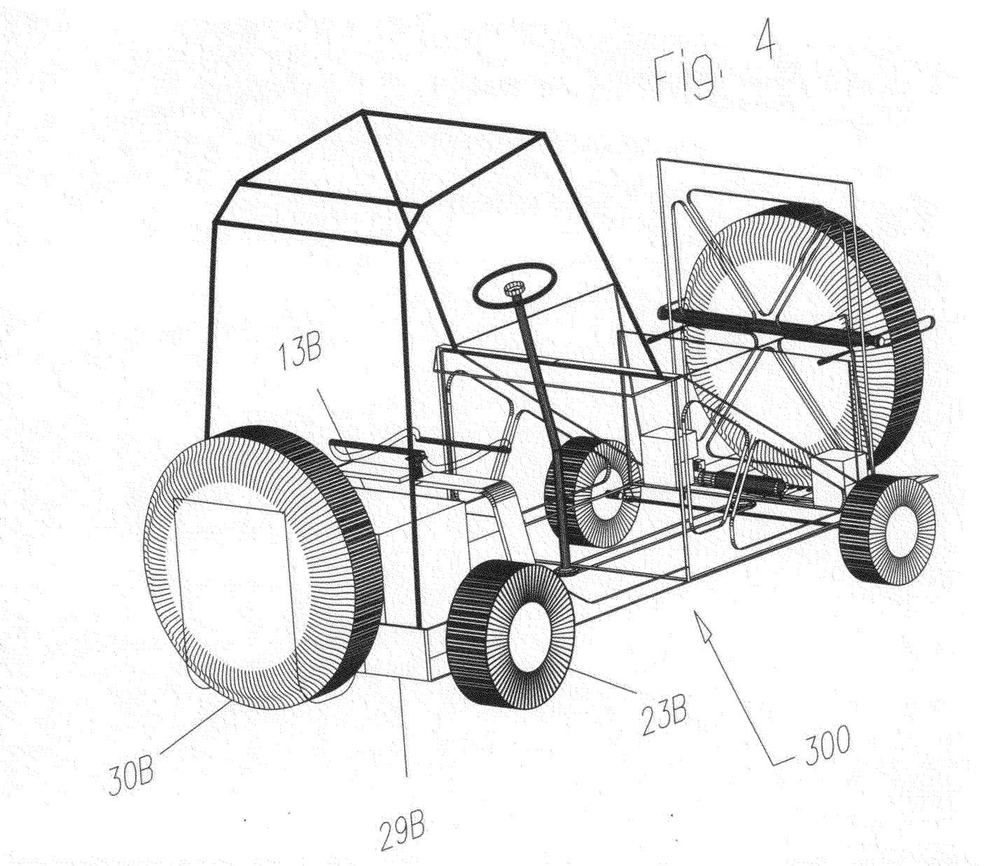

FIG. 1 is a side view showing an apparatus 100 that includes a housing 27 that may include a front bracing section 18 and may include a tread belt 4 that has wheels 23. Apparatus 100 may also use plurality of wheels as in FIG. 4. Apparatus 100 may include a lift 7 to enable manipulating and recovery of at least one wheel 30, as shown in FIG. 2. Lift 7 may be attached to front section 18 by pivoting means 3 or any other means.

Apparatus 100 may include a power source such as a mechanical or electrical engine 13, which may be of any type of an engine. Engine 13 may be disposed in housing 27 and may be linked to motor assembly frame 20. Motor assembly frame 20 may be linked to steering linkage 21, which may be attached to wheels 23 of tread belt 4. Steering linkage 21 may be connected to steering column 16 that may terminate with steering wheel 11. Apparatus 100 may be controlled via control console 15. A control seat 14 may be used by an operator to run apparatus 100.

FIG. 2 is an exploded view illustrating an alternative embodiment showing apparatus 200 that include lift 7A. Lift 7A may include tire base plate 1A for receiving tire 30, which may contain tire roller bearings 5A to stabilize tire 30. Lift 7A may also include a tire rest plate 17A for supporting tire 30. Tire rest plate 17A may be operatively connected to tire base plate 1A. Lift 17A may be pivotally attached to front brace section 18A.

Lift 7A may be hydraulically controlled via hydraulic cylinder 8A that moves lift 7A in an upwardly direction to pick up a defective tire and downwardly to unload the defective tire or in any other direction.

Lift 7A may also include handler mechanism, such as extending arms 2A. Extending arms 2A are capable of expanding laterally to receive defective tire, or contracting laterally to secure and retain defective tire, or expanding laterally to unload defective tire or good tire.

Apparatus 200 may also include a compressing means 26 to provide air supply to inflate tire. Compressor means 26 may also enable lifting the heavy vehicle via use of any type of lifting devices, such as pneumatic jacks, not shown, or any other mechanism known for those skilled in the art.

Mechanism of Work

To change defective tires of a heavy vehicle, not shown here, an operator drives apparatus 200 and position it across from the defective tire of the vehicle. The operator may use any type of lifting device that may be carried or stored anywhere in housing 27A. Compressing means 26 may also supply air to operate the lifting device to lift the heavy vehicle.

The operator may drive lift 7A to position tire plate 1A underneath a defective tire to facilitate unscrewing of the lugs of the defective tire. The operator may then contract arms 2A laterally to secure and retain the defective tire to facilitate unplugging the defective tire and unloading it from the vehicle. After unplugging the defective tire, the operator may back up apparatus 200 and drive apparatus 200 to the good tire rack and replace the defective tire with the good tire.

Apparatus 200 may have the ability to inflate flat tires by supplying air from compressing means 26 via hoses or any other means, which may be stores in apparatus 200, to the defective tire.

Apparatus 200 may be used to load the good tire via lift 7A and using extending arms 2A to secure and retain the good tire. The operator may drive apparatus 200 with the good tire to load the good tire on the vehicle. The operator may move lift 7A vertically upwardly to load the good tire on the vehicle.

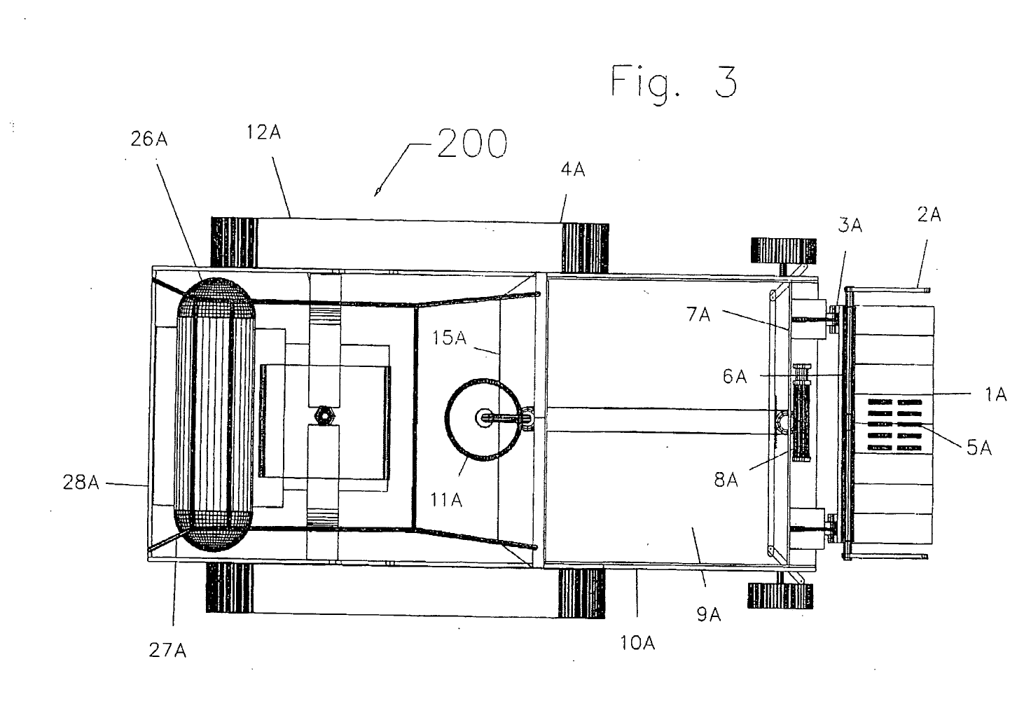

FIG. 3 shows a plan view of apparatus 200, shown in FIG. 2. Apparatus 200 may include lift 7A that may be powered by hydraulic power or any other means. Lift 7A may tilt forwardly and backwardly to unable loading and unloading of tires. Lift 7A may be pivotally linked to front section 18A to enable lift assembly 7A to tilt accordingly. Apparatus 200 may include a bin 28A that may be used to store tools and pneumatic jacks and so forth. Bin 28A may be operationally connected to compressing means 26A to supply air to pneumatic jacks or any other tools in bin 28A.

FIG. 4 shows another embodiment 300 according to the principles of the present invention. Apparatus 300 may be a wheeled apparatus having wheels 23B and may be powered by a motor 13B. Apparatus 300 may also include an additional section 29B for holding at least one good tire 30B to enable unloading of the defective tire and loading of the good tire 30B on the spot.

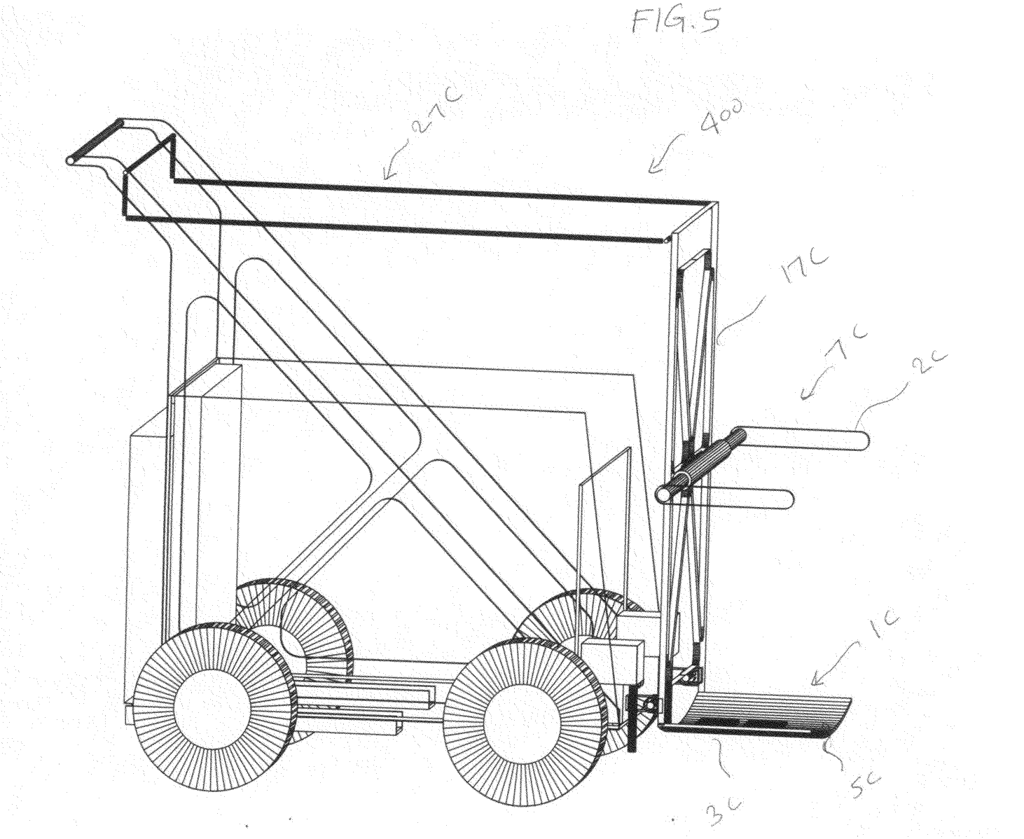

FIG. 5 shows another embodiment 400 of the present invention. Apparatus 400 is a manually operated machine and may include similar parts disclosed in powered apparatus according to the present invention. Apparatus 400 may include housing 27C that may include lift 7C operatively attached to housing 27C, capable of moving in different directions for picking, loading and unloading of tires. Lift 7C may include Lift 7A may include tire base plate 1C for receiving tires. Tire resting place 1C may contain tire roller bearings 5C to stabilize tires. Lift 7C may also include a tire rest plate 17C for supporting tires. Tire rest plate 17C may be operatively connected to tire base plate 1C.

Lift 7C may also include handler mechanism, such as extending arms 2C. Extending arms 2C are capable of expanding laterally to receive defective tire, or contracting laterally to secure and retain defective tire, or expanding laterally to unload defective tire or good tire.

The above description is not intended to limit the meaning of the words used in the following claim that define the invention. Persons of ordinary skill in the art will understand that a variety of other designs still falling within the scope of the following claims may be envisioned and used. It is contemplated that future modifications in structure, function, or result will exist that are not substantial changes and that all such insubstantial changes in what is claimed are intended to be covered by the claims.

I claim:

1. A apparatus adapted for manipulating and recovering wheels, the apparatus comprising: a housing, a lift for lifting the wheels, wherein the lift being operatively connected to the housing, and wherein the lift further includes a handler mechanism, and wherein the handler mechanism is movable between an open position for receiving the wheel and a closed position for retaining and securing the wheel.

2. The apparatus of claim 1 wherein the lift includes a tire rest plate for supporting a tire, and wherein the tire rest plate is operatively connected to roller bearings for retaining the tire.

3. The apparatus of claim 1 wherein the housing further includes a front framing section having a mechanism for tilting and pivoting the lift to enable loading and unloading of the wheel.

4. The apparatus of claim 4 wherein the handler mechanism includes at least one retainer arm for retaining the wheel.

5. The apparatus of claim 1 wherein the housing further includes a motor, a motor assembly frame operationally connected to the housing, a steering linkage operationally connected to the motor assembly frame, a steering column operationally connected to the steering linkage and a control console for controlling the apparatus.

6. The apparatus of claim 1 wherein the apparatus is configured to inflate tires.

7. The apparatus of claim 1 further including at least one lifting mechanism for lifting a vehicle to enable manipulation and recovery of the wheels.

8. An apparatus adapted for manipulating and recovery of wheels, the apparatus comprising: a housing, a power source to power the apparatus, a lift operatively attached to the housing for manipulating and recovering the wheels, and wherein the apparatus further being adapted to lift vehicles to enable manipulation and recovery of wheels.

9. The apparatus of claim 8 wherein the lift further includes at least one arm for controlling and manipulating the wheel.

10. The apparatus of claim 8 further including at least one air supply for inflating tires.

11. A apparatus adapted for manipulating and recovering wheels, the apparatus comprising: a means for powering the apparatus, a means for lifting and manipulating the wheels, and a means for inflating tires.

12. The apparatus of claim 11 further comprising a means for lifting vehicles.

13. The apparatus of claim 11 further comprising a remote controlling means.
